(19) United States
(12) Patent Application Publication
(10) Pub. No.: US 2026/0112558 A1
(43) Pub. Date: Apr. 23, 2026

(54) ELECTROMAGNETIC RELAY AND DETECTION SYSTEM

(71) Applicant: Panasonic Intellectual Property Management Co., Ltd., Osaka (JP)

(72) Inventors: HISASHI HIRAKI, Osaka (JP); MASAKAZU KOBAYASHI, Osaka (JP); KAZUHIRO KODAMA, Hokkaido (JP); RIICHI UOTOME, Osaka (JP); KAZUHISA KINOSHITA, Mie (JP)

(21) Appl. No.: 19/123,838

(22) PCT Filed: Nov. 13, 2023
(86) PCT No.: PCT/JP2023/040671

§ 371 Date: Apr. 24, 2025

Related U.S. Application Data
(60) Provisional application No. 63/426,993, filed on Nov. 21, 2022.

(51) Int. Cl. H01H 47/00; H01H 50/02; H01H 50/44; H01H 50/54; H01H 51/06

(52) U.S. Cl. CPC H01H 47/002; H01H 50/021; H01H 50/443; H01H 50/54; H01H 51/06

(57) ABSTRACT

Electromagnetic relay includes drive coil, movable iron core that moves in first direction and second direction based on driving of drive coil, movable contactor that is disposed in first direction with respect to movable iron core and moves between first position and second position with the movement of movable iron core, fixed terminal that comes into contact with movable contactor at first position and does not into contact with movable contactor at second position, yoke that has second direction end surface portion positioned in second direction with respect to drive coil, and detection coil that detects movable iron core. Detection coil is disposed in second direction with respect to second direction end surface portion. Movable iron core moves in a coil of detection coil with the movement in first direction and second direction.

### TECHNICAL FIELD

The present disclosure relates to an electromagnetic relay and a detection system including the electromagnetic relay.

### BACKGROUND ART

In related art, an electromagnetic relay that switches non-conduction and conduction of an electric path by opening or closing a contact point is known. PTL 1 discloses an electromagnetic relay that opens or closes a contact point by energizing a drive coil to move a movable iron core, detects the movable iron core by using a detection coil, and detects an open or close state of the contact point. In the electromagnetic relay illustrated in FIG. 2 of PTL 1, the detection coil is disposed around an outer periphery of a lower end portion of the movable iron core.

### CITATION LIST

### Patent Literature

PTL 1: Unexamined Japanese Patent Publication No. 2013-8623

### SUMMARY OF THE INVENTION

### Technical Problem

In the electromagnetic relay illustrated in FIG. 2 of PTL 1, the detection coil is disposed in a yoke surrounding the drive coil. Thus, there is a problem that detection accuracy of the detection coil decreases due to a magnetic field generated by the drive coil.

The present disclosure provides an electromagnetic relay or the like capable of suppressing a decrease in detection accuracy of a detection coil due to a magnetic field generated by a drive coil.

### Solution to Problem

An electromagnetic relay according to an aspect of the present disclosure includes a drive coil, a movable iron core that is disposed in a coil of the drive coil, the movable iron core moving in a first direction along a coil axis of the drive coil and a second direction opposite to the first direction based on driving of the drive coil, a movable contactor that is disposed in the first direction with respect to the movable iron core, the movable contactor being mechanically connected to the movable iron core and moving between a first position and a second position with the movement of the movable iron core, a fixed terminal that comes into contact with the movable contactor at the first position and does not come into contact with the movable contactor at the second position, a yoke that has a second-direction end surface portion positioned in the second direction with respect to the drive coil, and a detection coil that detects the movable iron core. The detection coil is disposed in the second direction with respect to the second-direction end surface portion of the yoke, and the movable iron core moves in a coil of the detection coil with the movement of the movable iron core in the first direction and the second direction.

A detection system according to another aspect of the present disclosure includes the electromagnetic relay, and a controller that is electrically connected to the detection coil of the electromagnetic relay. The controller determines welding between the fixed terminal and the movable contactor based on a conductance or an inductance of the detection coil.

### Advantageous Effect of Invention

According to the electromagnetic relay and the like of the present disclosure, it is possible to suppress the decrease in detection accuracy of the detection coil due to the magnetic field generated by the drive coil.

### BRIEF DESCRIPTION OF THE DRAWINGS

FIG. 1 is a diagram illustrating a detection system and an electromagnetic relay according to a first exemplary embodiment.

FIG. 2 is a sectional view illustrating a state where a contact point of the electromagnetic relay according to the first exemplary embodiment is closed.

FIG. 3 is a sectional view illustrating a state where the contact point of the electromagnetic relay according to the first exemplary embodiment is opened.

FIG. 4 is a diagram schematically illustrating an operation of the electromagnetic relay according to the first exemplary embodiment.

FIG. 5 is a diagram schematically illustrating an operation of the electromagnetic relay according to a modification of the first exemplary embodiment.

FIG. 6 is a diagram schematically illustrating an operation of the electromagnetic relay according to a second exemplary embodiment.

### DESCRIPTION OF EMBODIMENT

Hereinafter, exemplary embodiments will be specifically described with reference to the drawings.

Note that, the exemplary embodiment to be described below is intended to provide comprehensive or specific examples. Numerical values, shapes, components, disposed positions and connection forms of the components, and the like to be presented in the following exemplary embodiment are illustrative and are not to limit the present disclosure. In addition, among the components in the following exemplary embodiment, components not recited in the independent claims are described as any components.

In addition, each of the drawings is a schematic diagram, and is not necessarily strictly illustrated. As a result, for example, scales and the like do not necessarily coincide in the drawings. In addition, in each drawing, substantially identical components are denoted by identical reference marks, and the redundant description will be omitted or simplified.

In addition, in the present specification, terms indicating relationships between elements, such as orthogonal, parallel, and same, and terms indicating a shape of an element, such as rectangular shape and circular shape, numerical values, and numerical ranges are not expressions representing only strict meanings, but are expressions meaning to include a substantially equivalent range, for example, a difference of about several % (for example, about 10%).

### First Exemplary Embodiment

### [Configuration of Detection System and Electromagnetic Relay]

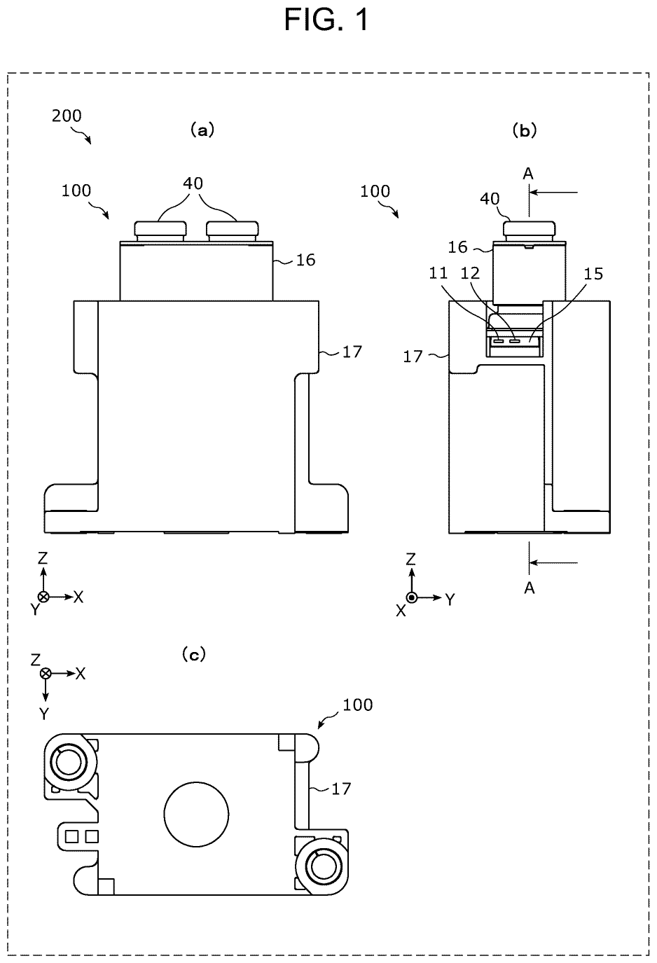

A configuration of a detection system and an electromagnetic relay according to a first exemplary embodiment will be described with reference to FIGS. 1 to 4.

FIG. 1 is a diagram illustrating detection system 200 and electromagnetic relay 100 according to the first exemplary embodiment. Part (a) of FIG. 1 is a front view, part (b) of FIG. 1 is a side view, and part (c) of FIG. 1 is a bottom view.

As illustrated in FIG. 1, electromagnetic relay 100 includes lower housing 17 serving as a base, upper housing 16 provided on lower housing 17, and a pair of fixed terminals 40 provided on upper housing 16. Wiring constituting a part of an electric path is connected to the pair of fixed terminals 40. Electromagnetic relay 100 switches non-conduction and conduction between the pair of fixed terminals 40 inside upper housing 16 to open or close a contact point, and switches non-conduction and conduction of the electric path.

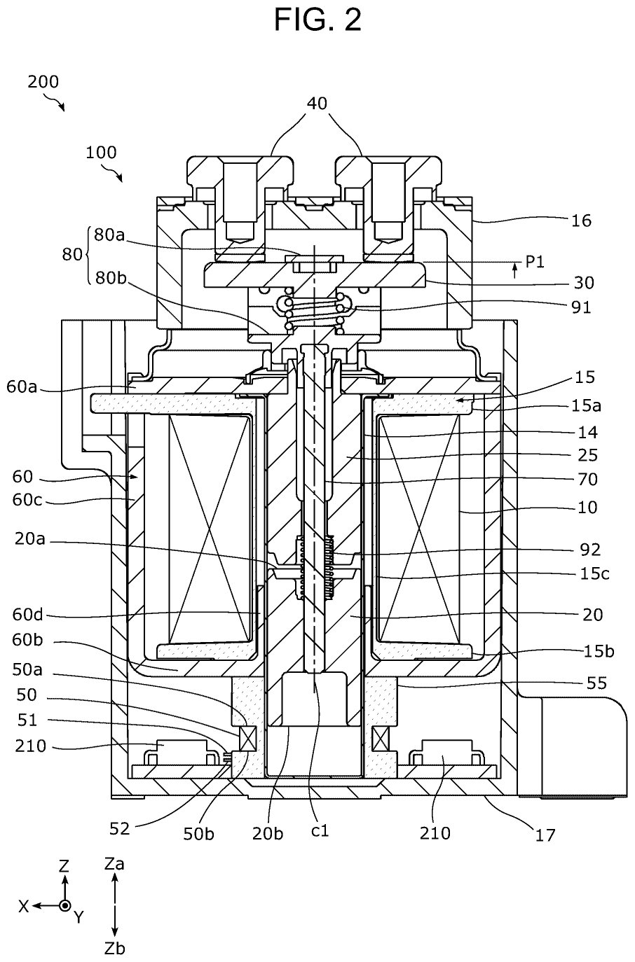

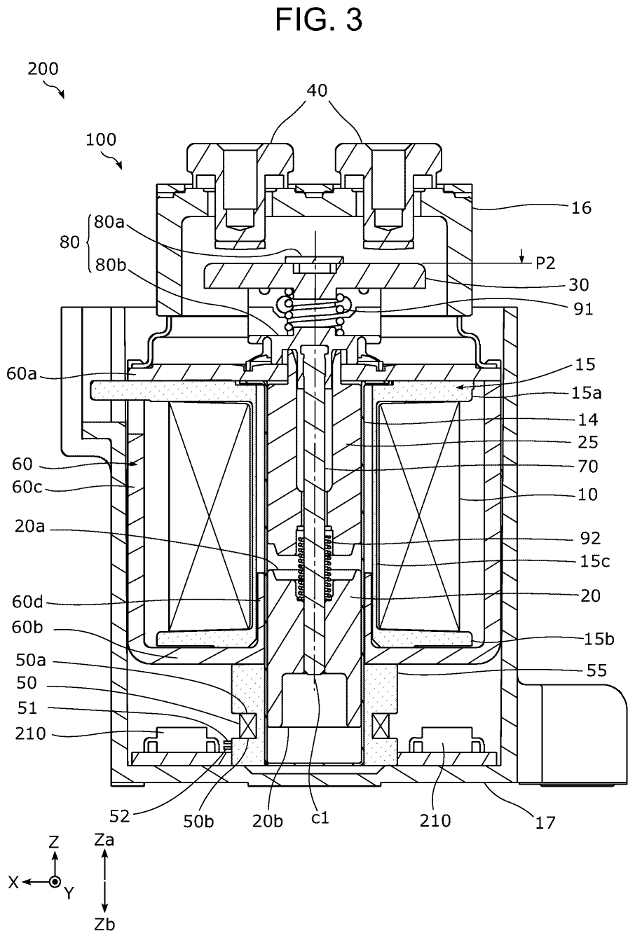

FIG. 2 is a sectional view illustrating a state where the contact point of electromagnetic relay 100 is closed. FIG. 3 is a sectional view illustrating a state where the contact point of electromagnetic relay 100 is opened. Each of FIGS. 2 and 3 illustrates a section taken along line A-A in FIG. 1.

Detection system 200 illustrated in FIGS. 2 and 3 includes electromagnetic relay 100 and controller 210.

Controller 210 is a device that controls driving of electromagnetic relay 100, and is, for example, a microprocessor. Controller 210 acquires information regarding an open or close state of the contact point by using a detection coil, and performs various types of processing based on the acquired information. In this example, controller 210 is provided inside electromagnetic relay 100.

Note that, controller 210 is not limited to the inside of electromagnetic relay 100, and may be provided outside electromagnetic relay 100. For example, in a case where electromagnetic relay 100 is used as a component of an automobile, controller 210 may include a part of a control device (for example, an electronic control unit (ECU)) of the automobile. Specific control contents of controller 210 will be described later.

Electromagnetic relay 100 includes drive coil 10, movable iron core 20 having a cylindrical shape, movable contactor 30, yoke 60, and detection coil 50. In addition, electromagnetic relay 100 includes cylinder 14 having a cylindrical shape, coil bobbin 15, fixed iron core 25 having a cylindrical shape, shaft 70 having a cylindrical shape, holder 80, insulating bobbin 55, and springs 91 and 92.

Drive coil 10, movable iron core 20, yoke 60, detection coil 50, cylinder 14, coil bobbin 15, fixed iron core 25, shaft 70, a part of holder 80, insulating bobbin 55, and spring 92 are provided inside lower housing 17. Movable contactor 30, a remaining part of holder 80, spring 91, and a part of fixed terminal 40 are provided inside upper housing 16.

Drive coil 10 is a component for moving movable iron core 20 and movable contactor 30. Drive coil 10 is a coil component having a cylindrical shape, and is formed by winding a conductive wire around coil bobbin 15. One end of both ends of drive coil 10 is connected to first drive terminal 11 (see part (b) of FIG. 1), and the other end is connected to second drive terminal 12. Drive coil 10 is energized, and thus, a magnetic field is generated inside and outside drive coil 10.

In the present disclosure, one direction along coil axis c1 of drive coil 10 is defined as first direction Za, and a direction opposite to first direction Za is defined as second direction Zb. As illustrated in FIGS. 2 and 3, in a case where electromagnetic relay 100 is disposed such that coil axis c1 is along a vertical direction, first direction Za is upward and second direction Zb is downward. In addition, an end of a predetermined component of electromagnetic relay 100 in first direction Za is an upper end, and an end of the predetermined component in second direction Zb is a lower end.

In the following description, a positional relationship between the components and the movement of the components may be described by using the words of upward and downward, an upper end and the lower end, an up direction and a down direction, and an up-down direction.

Cylinder 14 is a component having a cylindrical shape extending along the up-down direction. Cylinder 14 is disposed outside an outer periphery of each of movable iron core 20 and fixed iron core 25. Cylinder 14 guides the movement of movable iron core 20 when movable iron core 20 moves upward and downward.

Coil bobbin 15 is a component around which the conductive wire of drive coil 10 is wound, and is made of, for example, a resin material. Coil bobbin 15 includes tubular portion 15c disposed along coil axis c1 and two flange portions provided at both ends of tubular portion 15c. Tubular portion 15c is disposed outside movable iron core 20 and fixed iron core 25 and outside an outer periphery of cylinder 14. The two flange portions are disposed perpendicularly to coil axis c1. One flange portion 15a of the two flange portions is positioned above drive coil 10, and other flange portion 15b is positioned below drive coil 10.

Yoke 60 is a component for forming a magnetic circuit in electromagnetic relay 100. Yoke 60 has an annular and case-like shape. Yoke 60 may be an assembly component formed by a plurality of split yokes. In the present exemplary embodiment, yoke 60 is disposed to surround drive coil 10 and coil bobbin 15. In other words, drive coil 10 and coil bobbin 15 are accommodated inside yoke 60. Note that, detection coil 50 to be described later is not disposed inside yoke 60.

Yoke 60 has first-direction end surface portion 60a positioned in first direction Za (upward in this example) with respect to drive coil 10, second-direction end surface portion 60b positioned in second direction Zb (in this example, below) with respect to drive coil 10, and side surface portions positioned outside and inside drive coil 10. For example, second-direction end surface portion 60b and the side surface portions are formed by bending one sheet metal member, and first-direction end surface portion 60a is made of a sheet metal member having a flat shape.

First-direction end surface portion 60a and second-direction end surface portion 60b are disposed perpendicularly to coil axis c1. First-direction end surface portion 60a corresponds to a top surface portion of yoke 60, and is disposed above one flange portion 15a of coil bobbin 15. Second-direction end surface portion 60b corresponds to a bottom surface portion of yoke 60, and is disposed below other flange portion 15b of coil bobbin 15.

The side surface portions have outer-peripheral side surface portion 60c and inner-peripheral side surface portion 60d. Outer-peripheral side surface portion 60c and inner-peripheral side surface portion 60d are disposed in parallel to coil axis c1. Outer-peripheral side surface portion 60c is disposed outside drive coil 10 and coil bobbin 15, and magnetically connects first-direction end surface portion 60a and second-direction end surface portion 60b. Inner-peripheral side surface portion 60d is disposed between the outer periphery of cylinder 14 and tubular portion 15c of coil bobbin 15. Note that, inner-peripheral side surface portion 60d does not connect first-direction end surface portion 60a and second-direction end surface portion 60b, and is provided at a position lower than a height position of fixed iron core 25 in the up-down direction.

Drive coil 10 is energized, and thus, a magnetic field is formed. A magnetic flux is formed in yoke 60 by the magnetic field. As a result, a stable magnetic circuit is formed in electromagnetic relay 100.

Fixed iron core 25 is disposed in a coil of drive coil 10. An inside of the coil is a space region inside an inner periphery of the coil. Specifically, fixed iron core 25 is disposed inside cylinder 14 positioned in tubular portion 15c of coil bobbin 15. An outer peripheral side surface of fixed iron core 25 is in contact with an inner peripheral side surface of cylinder 14. Fixed iron core 25 is disposed above movable iron core 20. Fixed iron core 25 has a protrusion protruding upward, and the protrusion is fixedly connected to first-direction end surface portion 60a of yoke 60. Fixed iron core 25 has a through-hole along coil axis c1. Shaft 70 is inserted into the through-hole.

Shaft 70 is disposed along coil axis c1. Shaft 70 is not in contact with fixed iron core 25 and is movable in the up-down direction along the through-hole of fixed iron core 25. A lower end portion of shaft 70 is connected to movable iron core 20, and an upper end portion of shaft 70 is connected to holder 80. Shaft 70 transmits a force in the up direction or in the down direction applied from movable iron core 20 to holder 80.

A part of movable iron core 20 is disposed in the coil of drive coil 10. Specifically, movable iron core 20 is disposed inside cylinder 14 positioned in tubular portion 15c of coil bobbin 15. Movable iron core 20 has a through-hole along coil axis c1, and shaft 70 is press-fitted into the through-hole. Movable iron core 20 is disposed below fixed iron core 25 and is fixed to the lower end portion of shaft 70. Movable iron core 20 is movable upward or downward along the inner peripheral side surface of cylinder 14.

When drive coil 10 is energized, each of fixed iron core 25 and movable iron core 20 is magnetic. For example, in a case where an upper end portion of movable iron core 20 is an S pole, a lower end portion of movable iron core 20 is an N pole. At this time, an upper end portion of fixed iron core 25 is an N pole, and a lower end portion of fixed iron core 25 is an S pole. In addition, for example, in a case where the upper end portion of movable iron core 20 is the N pole, the lower end portion of movable iron core 20 is the S pole. At this time, the upper end portion of fixed iron core 25 is the S pole, and the lower end portion of fixed iron core 25 is the N pole.

As described above, when drive coil 10 is energized, since the upper end portion of movable iron core 20 and the lower end portion of fixed iron core 25 face each other at different magnetic poles, movable iron core 20 is attracted to fixed iron core 25, and movable iron core 20 moves upward.

At this time, a side surface of movable iron core 20 faces second-direction end surface portion 60b of yoke 60 even before movable iron core 20 moves upward or after movable iron core 20 moves upward.

As movable iron core 20 moves upward, shaft 70 and holder 80 move upward, and spring 91 and movable contactor 30 connected to holder 80 also move upward.

Holder 80 is a component for connecting shaft 70 and movable contactor 30, and holds movable contactor 30 together with spring 91 provided inside holder 80. Holder 80 includes upper holder 80a and lower holder 80b connected to upper holder 80a.

Lower holder 80b is fixed to the upper end portion of shaft 70. Lower holder 80b is made of, for example, a resin material, and is integrally molded with the upper end portion of shaft 70. An upper end portion of upper holder 80a comes into contact with the upper end portion of movable contactor 30 to prevent spring 91 from jumping out of movable contactor 30.

Spring 91 is provided between lower holder 80b and movable contactor 30. Spring 91 is a compression spring, and is disposed to be able to expand and contract in the up-down direction. Spring 91 is provided to alleviate an impact when movable contactor 30 moves upward and comes into contact with fixed terminal 40 and to press movable contactor 30 against fixed terminal 40 by using an elastic force.

Movable contactor 30 is a component that is separated from and comes into contact with fixed terminal 40 when the contact point is opened and closed. Movable contactor 30 is disposed in first direction Za (in this example, above) with respect to movable iron core 20 and fixed iron core 25, and is disposed in second direction Zb (in this example, below) with respect to fixed terminal 40.

Movable contactor 30 is mechanically connected to movable iron core 20. Specifically, movable contactor 30 is connected to movable iron core 20 via holder 80, spring 91, and shaft 70. As described above, movable contactor 30 moves upward or downward with the movement of movable iron core 20.

When drive coil 10 is energized, movable contactor 30 moves upward along with the movement of movable iron core 20, and moves to first position P1 coming into contact with fixed terminal 40 (see FIG. 2). First position P1 is a position where movable contactor 30 and fixed terminal 40 come into contact with each other.

Fixed terminal 40 comes into contact with movable contactor 30 having moved to first position P1. The pair of fixed terminals 40 comes into contact with movable contactor 30 at first position P1 to be in a conductive state.

When the energization to drive coil 10 is stopped, movable contactor 30 moves downward with the movement of movable iron core 20, and moves to second position P2 away from fixed terminal 40 (see FIG. 3). Second position P2 is a position where movable contactor 30 and fixed terminal 40 do not come into contact with each other. Specifically, second position P2 is a position determined by holder 80 moving downward and lower holder 80b abutting on first-direction end surface portion 60a.

Spring 92 is provided between fixed iron core 25 and movable iron core 20. Spring 92 is a compression spring, and is disposed to be able to expand and contract in the up-down direction. When drive coil 10 is energized and movable iron core 20 moves upward, spring 92 is compressed. When the energization to drive coil 10 is stopped, since an attraction force between fixed iron core 25 and movable iron core 20 is eliminated, spring 92 extends and movable iron core 20 moves downward. That is, the energization to drive coil 10 is stopped, and thus, movable iron core 20 moves to second position P2 by a restoring force of spring 92.

The pair of fixed terminals 40 does not come into contact with movable contactor 30 having moved to second position P2. The pair of fixed terminals 40 is brought into a non-conductive state by not coming into contact with movable contactor 30.

As described above, movable iron core 20 moves in first direction Za and second direction Zb (up-down direction in this example) based on the driving of drive coil 10.

A central portion and an upper end portion that are a part of movable iron core 20 are disposed in the coil of drive coil 10. The lower end portion that is another part of movable iron core 20 is disposed below drive coil 10. The lower end portion of movable iron core 20 has a hollow structure having a cavity. The lower end portion of movable iron core 20 moves in the coil of detection coil 50 with the movement of movable iron core 20 in the up-down direction.

Detection coil 50 detects the open or close state of the contact point by detecting movable iron core 20. Detection coil 50 is provided on insulating bobbin 55 disposed below yoke 60. Detection coil 50 is a coil component having a cylindrical shape, and is formed by winding a conductive wire in an annular groove of insulating bobbin 55.

Note that, for example, a coil height of detection coil 50 (a distance from an upper end of detection coil 50 to a lower end of detection coil 50) is preferably shorter than a coil height of drive coil 10. In addition, for example, the coil height of detection coil 50 is preferably shorter than a distance from upper end 20a to lower end 20b of movable iron core 20. In addition, for example, the total number of times of winding of the conductive wire of detection coil 50 is preferably smaller than the total number of times of winding of the conductive wire of drive coil 10. With these configurations, detection coil 50 can be provided in the electromagnetic relay while suppressing an increase in size of the electromagnetic relay.

In addition, a length of the conductive wire of drive coil 10 is preferably longer than a length of the conductive wire of detection coil 50. With this configuration, detection coil 50 can be set to be smaller than drive coil 10, and detection coil 50 can be provided while suppressing an increase in size of electromagnetic relay 100.

In addition, for example, a diameter of the conductive wire of detection coil 50 is preferably equal to or smaller than a diameter of the conductive wire of drive coil 10. In particular, the diameter of the conductive wire of detection coil 50 is preferably smaller than the diameter of the conductive wire of drive coil 10. In this case, the total number of times of winding can be increased while suppressing an increase in size of the coil, and detection accuracy of detection coil 50 can be improved.

One end of both ends of detection coil 50 is connected to first detection terminal 51, and the other end is connected to second detection terminal 52. That is, first detection terminal 51 and second detection terminal 52 are electrically connected via detection coil 50. First detection terminal 51 and second detection terminal 52 are provided on insulating bobbin 55 and are disposed below detection coil 50. Note that, drive coil 10 and fixed terminal 40 are not electrically connected to detection coil 50 in a section from first detection terminal 51 to second detection terminal 52 via detection coil 50.

Controller 210 detects a movement state of movable iron core 20 by applying a pulse voltage (or a step voltage) to detection coil 50. A voltage waveform of the pulse voltage is, for example, a rectangular wave, a triangular wave, a sine wave, or the like. In addition, for example, controller 210 detects a moving position, a moving distance, a moving speed, and the like of movable iron core 20.

The power supply to detection coil 50 for detecting movable iron core 20 is performed before the power supply to drive coil 10 is started, and the power supply to drive coil 10 for driving drive coil 10 is performed after the power supply to detection coil 50 is stopped. Note that, the power supply to detection coil 50 may be performed after the power supply to drive coil 10 is stopped. The power supply to detection coil 50 may be performed before the power supply to drive coil 10 is started or simultaneously with the power supply to drive coil 10.

In the present exemplary embodiment, since detection coil 50 is disposed in second direction Zb (below in this example) with respect to second-direction end surface portion 60b of yoke 60, detection coil 50 is disposed in a region less influenced by the magnetic field generated by drive coil 10. Thus, for example, the influence of the magnetic field generated by driving drive coil 10 and the residual magnetic field remaining after the driving of drive coil 10 is stopped on detection coil 50 can be reduced. As a result, it is possible to suppress a decrease in detection accuracy of detection coil 50 due to the magnetic field generated by drive coil 10.

In addition, in the present exemplary embodiment, flange portion 15b of coil bobbin 15 is disposed between detection coil 50 and drive coil 10. Since flange portion 15b is made of a resin material, flange portion 15b becomes a magnetic resistance, and the influence of the magnetic field generated by drive coil 10 on detection coil 50 can be suppressed.

In the present exemplary embodiment, as illustrated in FIG. 2, when movable contactor 30 is at first position P1, end (lower end) 20b of movable iron core 20 in second direction Zb is positioned in first direction Za (above) with respect to end (upper end) 50a of detection coil 50 in first direction Za. As illustrated in FIG. 3, when movable contactor 30 is at second position P2, end (lower end) 20b of movable iron core 20 in second direction Zb is positioned in second direction Zb (below) with respect to end (upper end) 50a of detection coil 50 in first direction Za, and is positioned, specifically, between upper end 50a and lower end 50b of detection coil 50. Note that, upper end 20a of movable iron core 20 is positioned above upper end 50a of detection coil 50 both when movable contactor 30 is at first position P1 and when the movable contactor is at second position P2.

In the present exemplary embodiment, an area of movable iron core 20 facing detection coil 50 in a case where movable contactor 30 is at first position P1 is different from an area of movable iron core 20 facing detection coil 50 in a case where movable contactor 30 is at second position P2.

Specifically, the area of movable iron core 20 facing detection coil 50 in a case where movable contactor 30 is at first position P1 is smaller than the area of movable iron core 20 facing detection coil 50 in a case where movable contactor 30 is at second position P2. When there is a difference in the facing areas as described above, values detected by detection coil 50 are different, and it can be determined whether movable contactor 30 is at first position P1 or second position P2. As a result, for example, it is possible to determine whether or not movable contactor 30 is welded to fixed terminal 40.

Note that, in the present exemplary embodiment, although it has been described that movable iron core 20 is attracted to fixed iron core 25, fixed iron core 25 is not essential. For example, movable iron core 20 may be attracted by first-direction end surface portion 60a of yoke 60. As a result, since fixed iron core 25 can be omitted, it is possible to suppress the increase in size of electromagnetic relay 100.

In addition, in the present exemplary embodiment, although it has been described that detection coil 50 is disposed below second-direction end surface portion 60b of the yoke, detection coil 50 may be disposed above first-direction end surface portion 60a of yoke 60.

Hereinafter, a detection example using detection coil 50 will be described.

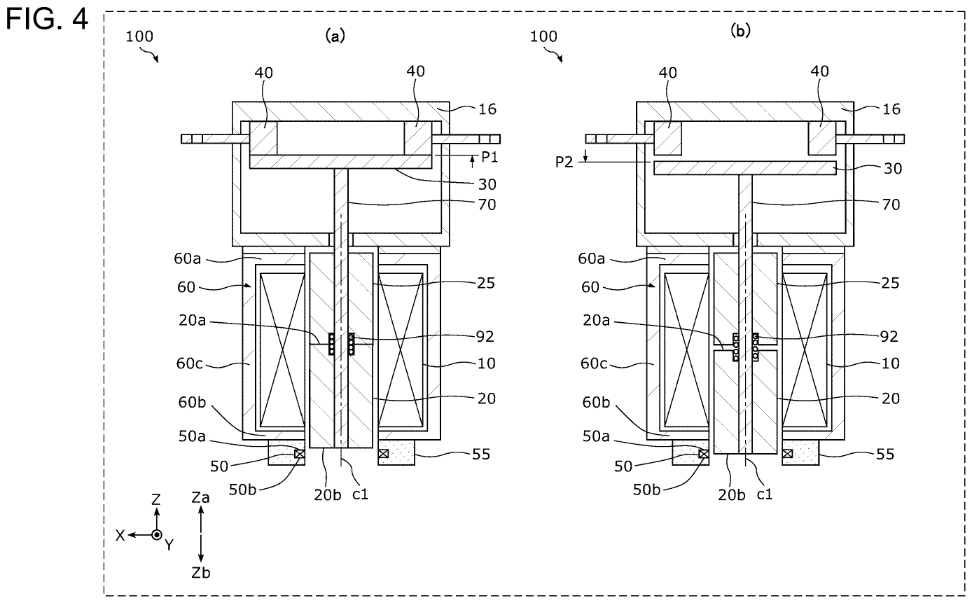

FIG. 4 is a diagram schematically illustrating an operation of electromagnetic relay 100. Part (a) of FIG. 4 illustrates a state where the contact point of electromagnetic relay 100 is closed, and part (b) of FIG. 4 illustrates a state where the contact point of electromagnetic relay 100 is opened.

Movable contactor 30 moves between first position P1 and second position P2 with the movement of movable iron core 20. A stroke of movable iron core 20 when the movable contactor moves between first position P1 and second position P2 is, for example, 2 mm.

Controller 210 is electrically connected to detection coil 50. Controller 210 applies an AC voltage to detection coil 50. In addition, controller 210 also determines whether or not movable contactor 30 and fixed terminal 40 are welded to each other based on a conductance or an inductance of detection coil 50.

Hereinafter, an example in which it is determined whether or not movable contactor 30 and fixed terminal 40 are welded to each other based on the conductance of detection coil 50 will be described. Note that, the conductance is derived from the following Equation 1 based on a parallel resonance circuit of LR and C representing an equivalent circuit of detection coil 50.

$$G = CR / L \qquad ( Equation 1 )$$

G: conductance, C: capacity, R: magnetoresistance, L: inductance

For example, a value of the conductance in a case where movable contactor 30 is at first position P1 as illustrated in part (a) of FIG. 4 is larger than a value of the conductance in a case where movable contactor 30 is at second position P2 as illustrated in part (b) of FIG. 4.

On the other hand, in a case where movable contactor 30 and fixed terminal 40 are welded to each other, even though the energization to drive coil 10 is stopped, movable contactor 30 does not move to second position P2 and is positioned at first position P1 or near first position P1. Thus, the value of the conductance when the energization to drive coil 10 is stopped in a case where movable contactor 30 and fixed terminal 40 are welded to each other is larger than in a case where these components are not welded to each other.

Controller 210 can determine whether or not movable contactor 30 and fixed terminal 40 are welded to each other by retaining, as a threshold, in advance a conductance for determining that movable contactor 30 and fixed terminal 40 are welded to each other.

In addition, controller 210 may determine whether or not movable contactor 30 and fixed terminal 40 are welded to each other based on a rate of change in conductance of detection coil 50.

Movable iron core 20 moves up and down by the driving of drive coil 10, but a moving distance of movable iron core 20 in a case where movable contactor 30 and fixed terminal 40 are welded to each other is shorter than a moving distance of movable iron core 20 in a case where movable contactor 30 and fixed terminal 40 are not welded to each other. In addition, a moving speed of movable iron core 20 in a case where movable contactor 30 and fixed terminal 40 are welded to each other is slower than a moving speed of movable iron core 20 in a case where movable contactor 30 and fixed terminal 40 are not welded to each other.

Thus, a rate of change in conductance of detection coil 50 in a case where movable contactor 30 and fixed terminal 40 are not welded to each other is smaller than a rate of change in conductance of detection coil 50 when movable contactor 30 and fixed terminal 40 are welded to each other.

Controller 210 can determine whether or not movable contactor 30 and fixed terminal 40 are welded to each other by retaining, as a threshold, in advance the rate of change in conductance for determining that movable contactor 30 and fixed terminal 40 are welded to each other.

### Modification of First Exemplary Embodiment

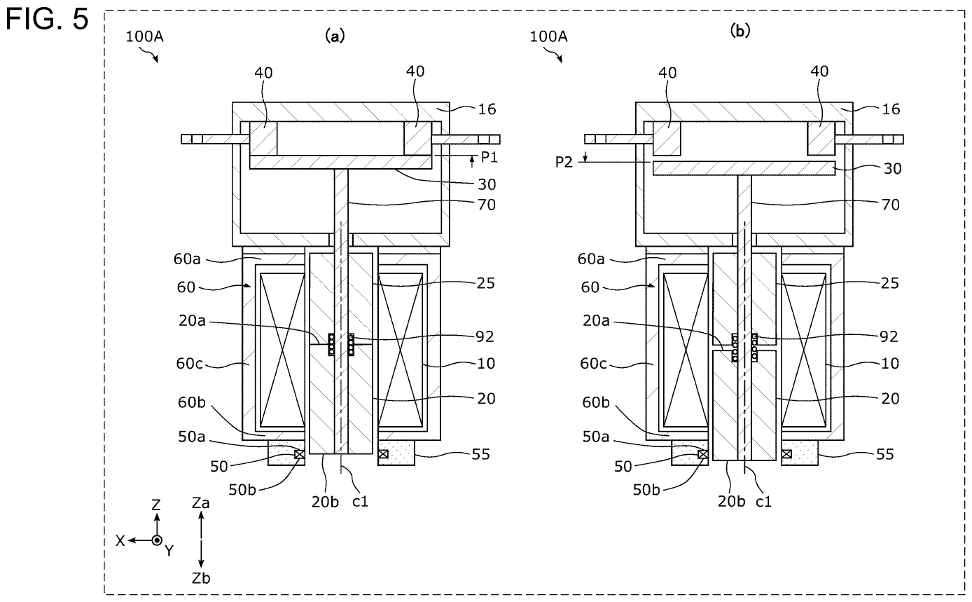

A configuration of electromagnetic relay 100A according to a modification of the first exemplary embodiment will be described with reference to FIG. 5. In the modification, an example in which lengths and positions of movable iron core 20 in an up-down direction at first position P1 and second position P2 are different from the lengths and positions in the first exemplary embodiment will be described.

FIG. 5 is a diagram schematically illustrating an operation of electromagnetic relay 100A. Part (a) of FIG. 5 illustrates a state where a contact point of electromagnetic relay 100A is closed, and part (b) of FIG. 5 illustrates a state where the contact point of electromagnetic relay 100A is opened.

Similarly to the first exemplary embodiment, electromagnetic relay 100A of the modification includes lower housing 17, upper housing 16, and a pair of fixed terminals 40. In addition, electromagnetic relay 100A of the modification includes drive coil 10, movable iron core 20, movable contactor 30, yoke 60, detection coil 50, insulating bobbin 55, fixed iron core 25, shaft 70, and spring 92. Note that, in FIG. 5, cylinder 14, coil bobbin 15, holder 80, spring 91, and the like are not illustrated.

In the modification, when movable contactor 30 is at first position P1, end (lower end) 20b of movable iron core 20 in second direction Zb is positioned between end (upper end) 50a of detection coil 50 in first direction Za and end (lower end) 50b of detection coil 50 in second direction Zb. In addition, when movable contactor 30 is positioned at second position P2, end (lower end) 20b of movable iron core 20 in second direction Zb is positioned in second direction Zb (below) with respect to end (lower end) 50b of detection coil 50 in second direction Zb. Note that, upper end 20a of movable iron core 20 is positioned above upper end 50a of detection coil 50 both when movable contactor 30 is at first position P1 and when the movable contactor is at second position P2.

In the present modification, an area of movable iron core 20 facing detection coil 50 in a case where movable contactor 30 is at first position P1 is different from an area of movable iron core 20 facing detection coil 50 in a case where movable contactor 30 is at second position P2.

Specifically, the area of movable iron core 20 facing detection coil 50 in a case where movable contactor 30 is at first position P1 is smaller than the area of movable iron core 20 facing detection coil 50 in a case where movable contactor 30 is at second position P2. When there is a difference in the facing areas as described above, values detected by detection coil 50 are different, and it can be determined whether movable contactor 30 is at first position P1 or second position P2. As a result, it is possible to determine whether or not movable contactor 30 is welded to fixed terminal 40.

### Second Exemplary Embodiment

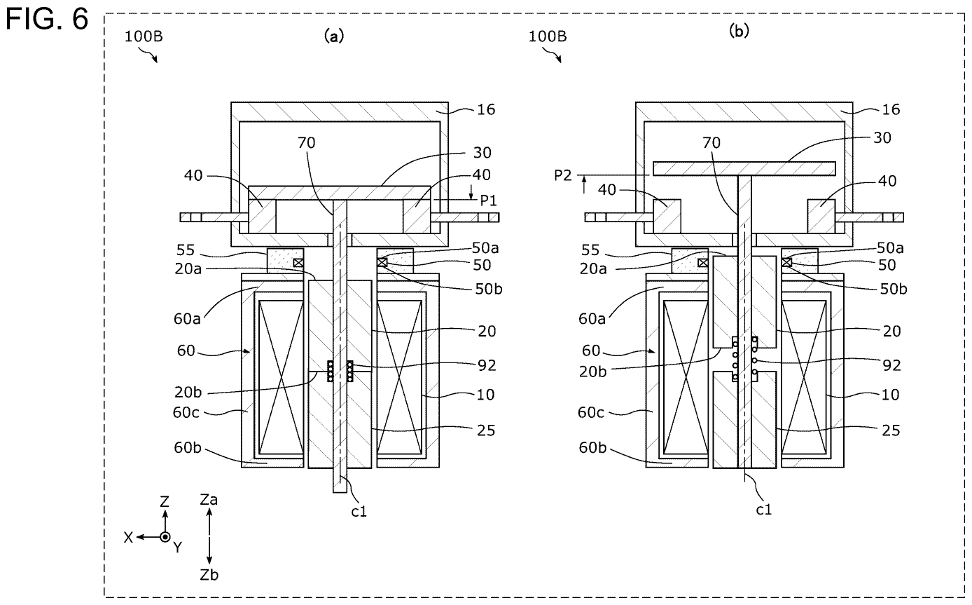

A configuration of electromagnetic relay 100B according to a second exemplary embodiment will be described with reference to FIG. 6. In the second exemplary embodiment, an example in which detection coil 50 is provided above yoke 60 will be described. In the second exemplary embodiment, first position P1 is positioned below second position P2. In other words, in the second exemplary embodiment, fixed terminal 40 is positioned below movable contactor 30.

FIG. 6 is a diagram schematically illustrating an operation of electromagnetic relay 100B. Part (a) of FIG. 6 illustrates a state where a contact point of electromagnetic relay 100B is closed, and part (b) of FIG. 6 illustrates a state where the contact point of electromagnetic relay 100B is opened.

Similarly to the first exemplary embodiment, electromagnetic relay 100B of the second exemplary embodiment includes lower housing 17, upper housing 16, and a pair of fixed terminals 40. In addition, electromagnetic relay 100B of the second exemplary embodiment includes drive coil 10, movable iron core 20, movable contactor 30, yoke 60, detection coil 50, insulating bobbin 55, fixed iron core 25, shaft 70, and spring 92. Note that, in FIG. 6, cylinder 14, coil bobbin 15, holder 80, spring 91, and the like are not illustrated.

In the second exemplary embodiment, positions where detection coil 50, fixed terminal 40, movable iron core 20, fixed iron core 25, and the like are disposed are different from the positions in the first exemplary embodiment.

Drive coil 10 is a component for moving movable iron core 20 and movable contactor 30. Drive coil 10 is a coil component having a cylindrical shape, and is formed by winding a conductive wire around coil bobbin 15. Drive coil 10 is energized, and thus, a magnetic field is generated inside and outside drive coil 10.

Yoke 60 is a component for forming a magnetic circuit in electromagnetic relay 100B. In this drawing, yoke 60 is disposed to surround drive coil 10. In other words, drive coil 10 is accommodated inside yoke 60. Note that, detection coil 50 is not disposed inside yoke 60.

Yoke 60 has first-direction end surface portion 60a positioned in first direction Za (upward in this example) with respect to drive coil 10, second-direction end surface portion 60b positioned in second direction Zb (in this example, below) with respect to drive coil 10, and side surface portions positioned outside and inside drive coil 10.

First-direction end surface portion 60a and second-direction end surface portion 60b are disposed perpendicularly to coil axis c1. First-direction end surface portion 60a corresponds to a top surface portion of yoke 60. Second-direction end surface portion 60b corresponds to a bottom surface portion of yoke 60.

The side surface portion is disposed in parallel to coil axis c1. The side surface portion is disposed outside drive coil 10 and magnetically connects first-direction end surface portion 60a and second-direction end surface portion 60b.

Fixed iron core 25 is disposed in a coil of drive coil 10. Fixed iron core 25 is disposed below movable iron core 20. Fixed iron core 25 has a through-hole along coil axis c1. Shaft 70 is inserted into the through-hole.

Shaft 70 is disposed along coil axis c1. Shaft 70 is not in contact with fixed iron core 25 and is movable in the up-down direction along the through-hole of fixed iron core 25. A central portion of shaft 70 is connected to movable iron core 20, and an upper end portion of shaft 70 is connected to movable contactor 30. Shaft 70 transmits a force in the up direction or in the down direction applied from movable iron core 20 to movable contactor 30.

A part of movable iron core 20 is disposed in the coil of drive coil 10. Movable iron core 20 has a through-hole along coil axis c1, and shaft 70 is press-fitted into the through-hole. Movable iron core 20 is disposed above fixed iron core 25 and is fixed to a central portion of shaft 70. Movable iron core 20 is movable upward or downward.

When drive coil 10 is energized, each of fixed iron core 25 and movable iron core 20 is magnetic. For example, in a case where an upper end portion of movable iron core 20 is an S pole, a lower end portion of movable iron core 20 is an N pole. At this time, an upper end portion of fixed iron core 25 is an N pole, and a lower end portion of fixed iron core 25 is an S pole. In addition, for example, in a case where the upper end portion of movable iron core 20 is the N pole, the lower end portion of movable iron core 20 is the S pole. At this time, the upper end portion of fixed iron core 25 is the S pole, and the lower end portion of fixed iron core 25 is the N pole.

As described above, when drive coil 10 is energized, since the upper end portion of movable iron core 20 and the lower end portion of fixed iron core 25 face each other at different magnetic poles, movable iron core 20 is attracted to fixed iron core 25, and movable iron core 20 moves downward. As movable iron core 20 moves downward, shaft 70 moves downward, and movable contactor 30 connected to shaft 70 also moves downward.

Movable contactor 30 is a component that is separated from and comes into contact with fixed terminal 40 when the contact point is opened and closed. Movable contactor 30 is disposed in first direction Za (in this example, above) with respect to movable iron core 20 and fixed iron core 25, and is disposed in first direction Za (in this example, above) with respect to fixed terminal 40.

Movable contactor 30 is mechanically connected to movable iron core 20. Specifically, movable contactor 30 is connected to movable iron core 20 via shaft 70. Movable contactor 30 moves upward or downward with the movement of movable iron core 20.

When drive coil 10 is energized, movable contactor 30 moves downward along with the movement of movable iron core 20, and moves to first position P1 coming into contact with fixed terminal 40 (see part (a) of FIG. 6). First position P1 is a position where movable contactor 30 and fixed terminal 40 come into contact with each other.

Fixed terminal 40 comes into contact with movable contactor 30 having moved to first position P1. The pair of fixed terminals 40 comes into contact with movable contactor 30 at first position P1 to be in a conductive state.

When the energization to drive coil 10 is stopped, movable contactor 30 moves upward along with the movement of movable iron core 20, and moves to second position P2 away from fixed terminal 40 (see part (b) of FIG. 6). Second position P2 is a position where movable contactor 30 and fixed terminal 40 do not come into contact with each other.

Spring 92 is provided between fixed iron core 25 and movable iron core 20. Spring 92 is a compression spring, and is disposed to be able to expand and contract in the up-down direction. When drive coil 10 is energized and movable iron core 20 moves downward, spring 92 is compressed. When the energization to drive coil 10 is stopped, since an attraction force between fixed iron core 25 and movable iron core 20 is eliminated, spring 92 extends and movable iron core 20 moves upward. That is, the energization to drive coil 10 is stopped, and thus, movable iron core 20 moves to second position P2 by a restoring force of spring 92.

The pair of fixed terminals 40 does not come into contact with movable contactor 30 having moved to second position P2. The pair of fixed terminals 40 is brought into a non-conductive state by not coming into contact with movable contactor 30.

As described above, movable iron core 20 moves in first direction Za and second direction Zb (up-down direction in this example) based on the driving of drive coil 10.

A central portion and a lower end portion which are a part of movable iron core 20 are disposed in the coil of drive coil 10. An upper end portion that is another part of movable iron core 20 is disposed above drive coil 10. The upper end portion of movable iron core 20 moves in the coil of detection coil 50 with the movement of movable iron core 20 in the up-down direction.

Detection coil 50 detects the open or close state of the contact point by detecting movable iron core 20. Detection coil 50 is provided on insulating bobbin 55 disposed above yoke 60. Detection coil 50 is a coil component having a cylindrical shape, and is formed by winding a conductive wire around insulating bobbin 55.

Note that, for example, a coil height of detection coil 50 (a distance from an upper end of detection coil 50 to a lower end of detection coil 50) is preferably shorter than a coil height of drive coil 10. In addition, for example, the coil height of detection coil 50 is preferably shorter than a distance from upper end 20a to lower end 20b of movable iron core 20. In addition, for example, the total number of times of winding of the conductive wire of detection coil 50 is preferably smaller than the total number of times of winding of the conductive wire of drive coil 10. With these configurations, detection coil 50 can be provided in the electromagnetic relay while suppressing an increase in size of the electromagnetic relay.

In addition, a length of the conductive wire of drive coil 10 is preferably longer than a length of the conductive wire of detection coil 50. With this configuration, detection coil 50 can be set to be smaller than drive coil 10, and detection coil 50 can be provided while suppressing an increase in size of electromagnetic relay 100B.

In addition, for example, a diameter of the conductive wire of detection coil 50 is preferably equal to or smaller than a diameter of the conductive wire of drive coil 10. In particular, the diameter of the conductive wire of detection coil 50 is preferably smaller than the diameter of the conductive wire of drive coil 10. In this case, the total number of times of winding can be increased while suppressing an increase in size of the coil, and detection accuracy of detection coil 50 can be improved.

One end of both ends of detection coil 50 is connected to a first detection terminal, and the other end is connected to a second detection terminal (not illustrated). That is, the first detection terminal and the second detection terminal are electrically connected via detection coil 50. Note that, drive coil 10 and fixed terminal 40 are not electrically connected to detection coil 50 in a section from the first detection terminal to the second detection terminal via detection coil 50.

A controller (not illustrated) detects a movement state of movable iron core 20 by applying a pulse voltage (or a step voltage) to detection coil 50. A voltage waveform of the pulse voltage is, for example, a rectangular wave, a triangular wave, a sine wave, or the like. In addition, for example, the controller detects a moving position, a moving distance, a moving speed, and the like of movable iron core 20.

The power supply to detection coil 50 for detecting movable iron core 20 is performed before the power supply to drive coil 10 is started, and the power supply to drive coil 10 for driving drive coil 10 is performed after the power supply to detection coil 50 is stopped. Note that, the power supply to detection coil 50 may be performed after the power supply to drive coil 10 is stopped. The power supply to detection coil 50 may be performed before the power supply to drive coil 10 is started or simultaneously with the power supply to drive coil 10.

In the present exemplary embodiment, since detection coil 50 is disposed in first direction Za (in this example, above) with respect to first-direction end surface portion 60a of yoke 60, detection coil 50 is disposed in a region less influenced by the magnetic field generated by drive coil 10. Thus, for example, the influence of the magnetic field generated by driving drive coil 10 and the residual magnetic field remaining after the driving of drive coil 10 is stopped on detection coil 50 can be reduced. As a result, it is possible to suppress a decrease in detection accuracy of detection coil 50 due to the magnetic field generated by drive coil 10.

In the present exemplary embodiment, a flange portion of a coil bobbin is disposed between detection coil 50 and drive coil 10 (not illustrated). Since the flange portion is made of a resin material, the flange portion becomes a magnetic resistance, and the influence of the magnetic field of drive coil 10 on detection coil 50 can be suppressed.

In the present exemplary embodiment, as illustrated in part (a) of FIG. 6, when movable contactor 30 is at first position P1, end (upper end) 20a of movable iron core 20 in first direction Za is positioned in second direction Zb (below) with respect to end (lower end) 50b of detection coil 50 in second direction Zb. In addition, as illustrated in part (b) of FIG. 6, when movable contactor 30 is positioned at second position P2, end (upper end) 20a of movable iron core 20 in first direction Za is positioned in first direction Za (above) with respect to end (upper end) 50a of detection coil 50 in first direction Za. Note that, when movable contactor 30 is positioned at second position P2, upper end 20a of movable iron core 20 may be positioned between upper end 50a of detection coil 50 and lower end 50b of detection coil 50. Lower end 20b of movable iron core 20 is positioned below lower end 50b of detection coil 50 both when movable contactor 30 is at first position P1 and when the movable contactor is at second position P2.

Note that, the present disclosure is not limited to the above example, and a positional relationship between detection coil 50 and movable iron core 20 may be the following relationship. For example, when movable contactor 30 is at first position P1, upper end 20a of movable iron core 20 may be positioned between upper end 50a of detection coil 50 and lower end 50b of detection coil 50, and when movable contactor 30 is at second position P2, upper end 20a of movable iron core 20 may be positioned above upper end 50a of detection coil 50.

In the present exemplary embodiment, an area of movable iron core 20 facing detection coil 50 in a case where movable contactor 30 is at first position P1 is different from an area of movable iron core 20 facing detection coil 50 in a case where movable contactor 30 is at second position P2.

Specifically, the area of movable iron core 20 facing detection coil 50 in a case where movable contactor 30 is at first position P1 is smaller than the area of movable iron core 20 facing detection coil 50 in a case where movable contactor 30 is at second position P2. When there is a difference in the facing areas as described above, values detected by detection coil 50 are different, and it can be determined whether movable contactor 30 is at first position P1 or second position P2. As a result, it is possible to determine whether or not movable contactor 30 is welded to fixed terminal 40.

Note that, in the present exemplary embodiment, although it has been described that movable iron core 20 is attracted to fixed iron core 25, fixed iron core 25 is not essential. For example, movable iron core 20 may be attracted by second-direction end surface portion 60b of yoke 60. As a result, since fixed iron core 25 can be omitted, it is possible to suppress the increase in size of electromagnetic relay 100. In addition, in the configuration in which movable iron core 20 is attracted to second-direction end surface portion 60b of yoke 60, for example, second-direction end surface portion 60b of yoke 60 preferably includes a portion extending toward movable iron core 20. As a result, magnetic efficiency between second-direction end surface portion 60b of yoke 60 and movable iron core 20 can be improved, and the increase in size of electromagnetic relay 100 can be further suppressed.

In addition, in the present exemplary embodiment, although it has been described that detection coil 50 is disposed above first-direction end surface portion 60a of the yoke, detection coil 50 may be disposed below second-direction end surface portion 60b of yoke 60.

### Conclusions

Electromagnetic relays 100, 100A, 100B and detection system 200 according to one aspect of the present disclosure will be described with reference to examples.

Electromagnetic relays 100 and 100A of Example 1 include drive coil 10, movable iron core 20 that is disposed in the coil of drive coil 10 and moves in first direction Za along coil axis c1 of drive coil 10 and second direction Zb opposite to first direction Za based on the driving of drive coil 10, movable contactor 30 that is disposed in first direction Za with respect to movable iron core 20, is mechanically connected to movable iron core 20, and moves between first position P1 and second position P2 with the movement of movable iron core 20, fixed terminal 40 that comes into contact with movable contactor 30 at first position P1 and does not come into contact with movable contactor 30 at second position P2, and yoke 60 that has second-direction end surface portion 60b positioned in second direction Zb with respect to drive coil 10, detection coil 50 that detects movable iron core 20. Detection coil 50 is disposed in second direction Zb with respect to second-direction end surface portion 60b of yoke 60. Movable iron core 20 moves in the coil of detection coil 50 with the movement in first direction Za and second direction Zb.

As described above, detection coil 50 is disposed in second direction Zb with respect to second-direction end surface portion 60b of yoke 60, and thus, detection coil 50 is disposed in a region less influenced by the magnetic field generated by drive coil 10. Thus, for example, the influence of the magnetic field generated by driving drive coil 10 and the residual magnetic field remaining after the driving of drive coil 10 is stopped on detection coil 50 can be reduced. As a result, it is possible to suppress a decrease in detection accuracy of detection coil 50 due to the magnetic field generated by drive coil 10.

Electromagnetic relay 100B of Example 2 includes drive coil 10, movable iron core 20 that is disposed in the coil of drive coil 10 and moves in first direction Za along coil axis c1 of drive coil 10 and second direction Zb opposite to first direction Za based on the driving of drive coil 10, movable contactor 30 that is disposed in first direction Za with respect to movable iron core 20, is mechanically connected to movable iron core 20, and moves between first position P1 and second position P2 with the movement of movable iron core 20, fixed terminal 40 that comes into contact with movable contactor 30 at first position P1 and does not come into contact with the movable contactor at second position P2, yoke 60 that has first-direction end surface portion 60a positioned in first direction Za with respect to drive coil 10, and detection coil 50 that detects movable iron core 20. Detection coil 50 is disposed in first direction Za with respect to first-direction end surface portion 60a of yoke 60. Movable iron core 20 moves in the coil of detection coil 50 with the movement in first direction Za and second direction Zb.

As described above, detection coil 50 is disposed in first direction Za with respect to first-direction end surface portion 60a of yoke 60, and thus, detection coil 50 is disposed in the region less influenced by the magnetic field generated by drive coil 10. Thus, for example, the influence of the magnetic field generated by driving drive coil 10 and the residual magnetic field remaining after the driving of drive coil 10 is stopped on detection coil 50 can be reduced. As a result, it is possible to suppress a decrease in detection accuracy of detection coil 50 due to the magnetic field generated by drive coil 10.

Electromagnetic relay 100, 100A, 100B of Example 3 is the electromagnetic relay according to Example 1 or 2, and the area of movable iron core 20 facing detection coil 50 when movable contactor 30 is at first position P1 may be smaller than the area of movable iron core 20 facing detection coil 50 when movable contactor 30 is at second position P2.

As described above, the area of movable iron core 20 facing detection coil 50 when the movable contactor is at first position P1 is set to be smaller than when the movable contactor is at second position P2, and thus, it is possible to determine whether movable contactor 30 is at first position P1 or second position P2. As a result, for example, it is possible to determine whether or not movable contactor 30 is welded to fixed terminal 40.

Electromagnetic relay 100 of Example 4 is the electromagnetic relay according to Example 1 or 3, and thus, when movable contactor 30 is at first position P1, end 20b of movable iron core 20 in second direction Zb may be positioned in first direction Za with respect to end 50a of detection coil 50 in first direction Za, and when movable contactor 30 is at second position P2, end 20b of movable iron core 20 in second direction Zb may be positioned in second direction Zb with respect to end 50a of detection coil 50 in first direction Za.

Accordingly, when movable contactor 30 is at first position P1, since movable iron core 20 is not present in the coil of detection coil 50, a difference between a detection value of detection coil 50 at first position P1 and a detection value of detection coil 50 at second position P2 can be increased. As a result, detection accuracy of detection coil 50 can be improved.

Electromagnetic relay 100A of Example 5 is the electromagnetic relay according to Example 1 or 3, and when movable contactor 30 is at first position P1, end 20b of movable iron core 20 in second direction Zb may be positioned between end 50a of detection coil 50 in first direction Za and end 50b of detection coil 50 in second direction Zb, and when movable contactor 30 is at second position P2, end 20b of movable iron core 20 in second direction Zb may be positioned in second direction Zb with respect to end 50b of detection coil 50 in second direction Zb.

According to this configuration, since a moving amount of movable iron core 20 can be shortened, electromagnetic relay 100A can be downsized.

Electromagnetic relay 100B of Example 6 is the electromagnetic relay according to Example 2, and when movable contactor 30 is at first position P1, end 20a of movable iron core 20 in first direction Za may be positioned in second direction Zb with respect to end 50b of detection coil 50 in second direction Zb, and when movable contactor 30 is at second position P2, end 20a of movable iron core 20 in first direction Za may be positioned in first direction Za with respect to end 50a of detection coil 50 in first direction Za.

Accordingly, when movable contactor 30 is at first position P1, since movable iron core 20 is not present in the coil of detection coil 50, a difference between a detection value of detection coil 50 at first position P1 and a detection value of detection coil 50 at second position P2 can be increased. As a result, detection accuracy of detection coil 50 can be improved.

An electromagnetic relay of Example 7 is the electromagnetic relay according to any of Examples 1 to 6, and the total number of times of winding of detection coil 50 may be less than the total number of times of winding of drive coil 10.

According to this configuration, a region of a detection block including detection coil 50 can be reduced, and the electromagnetic relay can be downsized.

An electromagnetic relay of example 8 is the electromagnetic relay according to any of Examples 1 to 6, and the length of the conductive wire of drive coil 10 may be greater than the length of the conductive wire of detection coil 50.

Accordingly, detection coil 50 can be set to be smaller than drive coil 10. As a result, detection coil 50 can be provided while suppressing the increase in size of the electromagnetic relay.

An electromagnetic relay of Example 9 is the electromagnetic relay according to any one of Examples 1 to 8, and further includes first detection terminal 51 electrically connected to detection coil 50 and second detection terminal 52 electrically connected to first detection terminal 51 via detection coil 50. Drive coil 10 and fixed terminal 40 may not be electrically connected to detection coil 50 in a section from first detection terminal 51 to second detection terminal 52 via detection coil 50.

According to this configuration, drive coil 10 and detection coil 50 can be independently controlled.

Detection system 200 of Example 10 includes the electromagnetic relay according to any of Examples 1 to 9 and controller 210 electrically connected to detection coil 50 of the electromagnetic relay. Controller 210 determines whether or not fixed terminal 40 and movable contactor 30 are welded to each other based on the conductance or the inductance of detection coil 50.

As in detection system 200, the welding between fixed terminal 40 and movable contactor 30 is determined based on the conductance or the inductance of detection coil 50, and thus, whether or not there is welding can be accurately determined. In addition, it is determined that there is welding by using detection coil 50, and thus, it is possible to suppress occurrence of a failure as compared with a detection system of the related art in which, for example, a mechanical switch is provided to determine that there is welding.

Detection system 200 of Example 11 is the detection system according to Example 10, and the power supply to detection coil 50 may be performed before the power supply to drive coil 10 is started, and the power supply to drive coil 10 may be performed after the power supply to detection coil 50 is stopped.

Accordingly, the power supply to detection coil 50 and the power supply to drive coil 10 are not simultaneously performed. As a result, it is possible to suppress a decrease in detection accuracy of detection coil 50 due to the magnetic field generated by drive coil 10.

Detection system 200 of Example 12 is the detection system according to Example 10, and the power supply to detection coil 50 may be performed after the power supply to drive coil 10 is stopped.

Accordingly, the power supply to detection coil 50 and the power supply to drive coil 10 are not simultaneously performed. As a result, it is possible to suppress a decrease in detection accuracy of detection coil 50 due to the magnetic field generated by drive coil 10.

Detection system 200 of Example 13 is the detection system according to Example 10, and the power supply to detection coil 50 may be performed before or simultaneously with the power supply to the 10 drive coil 10.

According to detection system 200, even though the power is supplied to drive coil 10 in a state where the power is supplied to detection coil 50, since detection coil 50 is disposed in the region less influenced by the magnetic field generated by drive coil 10, a decrease in detection accuracy of detection coil 50 can be suppressed. Note that, when power supply to detection coil 50 is stopped before movable contactor 30 and fixed terminal 40 come into contact with each other, erroneous detection can be further suppressed.

### Other Exemplary Embodiments

Although the electromagnetic relays and the like according to the exemplary embodiments have been described above, the present disclosure is not limited to such exemplary embodiments. Configurations in which various variations conceived by those skilled in the art are applied to the present exemplary embodiments, and configurations established by combining components in different exemplary embodiments may also fall within the present disclosure, without departing from the gist of the present disclosure.

In the present exemplary embodiment, although an example in which the first direction and the second direction are directions along the vertical direction has been described, the present disclosure is not limited thereto. For example, the first direction and the second direction may be directions along a horizontal direction. The first direction and the second direction may be oblique directions intersecting the vertical direction.

In the first exemplary embodiment, although an example in which lower end 20b of movable iron core 20 is positioned above upper end 50a of detection coil 50 when movable contactor 30 is at first position P1 and lower end 20b of movable iron core 20 is positioned below upper end 50a of detection coil 50 when movable contactor 30 is at second position P2 has been described, the present disclosure is not limited thereto. For example, when movable contactor 30 is at first position P1, lower end 20b of movable iron core 20 may be positioned at a first detection position between upper end 50a and lower end 50b of detection coil 50, and when movable contactor 30 is at second position P2, lower end 20b of movable iron core 20 may be positioned at a second detection position between upper end 50a and lower end 50b of detection coil 50 and below the first detection position.

The electromagnetic relay is mounted on, for example, a vehicle such as an automobile, an electrical product such as a home appliance, or the like. Note that, the electromagnetic relay may be mounted on an object having an electric circuit other than the automobile and the electrical product. In addition, the electromagnetic relay in the above exemplary embodiments and the like may be used in, for example, a power storage system, a power transmission system, and the like.

### INDUSTRIAL APPLICABILITY

The present disclosure is useful as a relay, a switch, a contact point switch device, and the like mounted on a vehicle such as an automobile, an electrical product such as a home appliance, and the like.

### REFERENCE MARKS IN THE DRAWINGS

10: drive coil
11: first drive terminal
12: second drive terminal
14: cylinder
15: coil bobbin
15a, 15b: flange portion
15c: tubular portion
16: upper housing
17: lower housing
20: movable iron core
20a: upper end (end in first direction)
20b: lower end (end in second direction)
25: fixed iron core
30: movable contactor
40: fixed terminal
50: detection coil
50a: upper end (end in first direction)
50b: lower end (end in second direction)
51: first detection terminal
52: second detection terminal
55: insulating bobbin
60: yoke
60a: first-direction end surface portion
60b: second-direction end surface portion
60c: outer-peripheral side surface portion
60d: inner-peripheral side surface portion
70: shaft
80: holder
80a: upper holder
80b: lower holder
91, 92: spring
100, 100A, 100B: electromagnetic relay
200: detection system
210: controller
c1: coil axis
P1: first position
P2: second position
Za: first direction
Zb: second direction

1. An electromagnetic relay comprising:
a drive coil;
a movable iron core that is disposed in a coil of the drive coil, the movable iron core moving in a first direction along a coil axis of the drive coil and a second direction opposite to the first direction based on driving of the drive coil;
a movable contactor that is disposed in the first direction with respect to the movable iron core, the movable contactor being mechanically connected to the movable iron core and moving between a first position and a second position with the movement of the movable iron core;
a fixed terminal that comes into contact with the movable contactor at the first position and does not come into contact with the movable contactor at the second position;
a yoke that has a second-direction end surface portion positioned in the second direction with respect to the drive coil; and
a detection coil that detects the movable iron core,
wherein the detection coil is disposed in the second direction with respect to the second-direction end surface portion of the yoke, and
the movable iron core moves in a coil of the detection coil with the movement of the movable iron core in the first direction and the second direction.

2. An electromagnetic relay comprising:
a drive coil;
a movable iron core that is disposed in a coil of the drive coil, the movable iron core moving in a first direction along a coil axis of the drive coil and a second direction opposite to the first direction based on driving of the drive coil;
a movable contactor that is disposed in the first direction with respect to the movable iron core, the movable contactor being mechanically connected to the movable iron core and moving between a first position and a second position with the movement of the movable iron core;
a fixed terminal that comes into contact with the movable contactor at the first position and does not come into contact with the movable contactor at the second position;
a yoke that has a first-direction end surface portion positioned in the first direction with respect to the drive coil; and
a detection coil that detects the movable iron core,
wherein the detection coil is disposed in the first direction with respect to the first-direction end surface portion of the yoke, and
the movable iron core moves in the coil of the detection coil with the movement of the movable iron core in the first direction and the second direction.

3. The electromagnetic relay according to claim 1, wherein an area of the movable iron core facing the detection coil when the movable contactor is at the first position is smaller than an area of the movable iron core facing the detection coil when the movable contactor is at the second position.

4. The electromagnetic relay according to claim 1, wherein
when the movable contactor is at the first position, an end of the movable iron core in the second direction is positioned in the first direction with respect to an end of the detection coil in the first direction, and
when the movable contactor is at the second position, the end of the movable iron core in the second direction is positioned in the second direction with respect to the end of the detection coil in the first direction.

5. The electromagnetic relay according to claim 1, wherein
when the movable contactor is at the first position, an end of the movable iron core in the second direction is positioned between an end of the detection coil in the first direction and an end of the detection coil in the second direction, and
when the movable contactor is at the second position, the end of the movable iron core in the second direction is positioned in the second direction with respect to the end of the detection coil in the second direction.

6. The electromagnetic relay according to claim 2, wherein
when the movable contactor is at the first position, an end of the movable iron core in the first direction is positioned in the second direction with respect to an end of the detection coil in the second direction, and
when the movable contactor is at the second position, the end of the movable iron core in the first direction is positioned in the first direction with respect to an end of the detection coil in the first direction.

7. The electromagnetic relay according to claim 1, wherein a total number of times of winding of the detection coil is smaller than a total number of times of winding of the drive coil.

8. The electromagnetic relay according to claim 1, wherein a length of a conductive wire of the drive coil is longer than a length of a conductive wire of the detection coil.

9. The electromagnetic relay according to claim 1, further comprising:
a first detection terminal that is electrically connected to the detection coil; and
a second detection terminal that is electrically connected to the first detection terminal via the detection coil,
wherein the drive coil and the fixed terminal are not electrically connected to the detection coil in a section from the first detection terminal to the second detection terminal via the detection coil.

10. A detection system comprising:
the electromagnetic relay according to claim 1; and
a controller that is electrically connected to the detection coil of the electromagnetic relay,
wherein the controller determines welding between the fixed terminal and the movable contactor based on a conductance or an inductance of the detection coil.

11. The detection system according to claim 10, wherein
power supply to the detection coil is performed before power supply to the drive coil is started, and
the power supply to the drive coil is performed after the power supply to the detection coil is stopped.

12. The detection system according to claim 10, wherein power supply to the detection coil is performed after power supply to the drive coil is stopped.

13. The detection system according to claim 10, wherein power supply to the detection coil is performed before power supply to the drive coil is started or simultaneously with the power supply to the drive coil.

14. The electromagnetic relay according to claim 2, wherein an area of the movable iron core facing the detection coil when the movable contactor is at the first position is smaller than an area of the movable iron core facing the detection coil when the movable contactor is at the second position.

15. The electromagnetic relay according to claim 2, wherein a total number of times of winding of the detection coil is smaller than a total number of times of winding of the drive coil.

16. The electromagnetic relay according to claim 2, wherein a length of a conductive wire of the drive coil is longer than a length of a conductive wire of the detection coil.

17. The electromagnetic relay according to claim 2, further comprising:
a first detection terminal that is electrically connected to the detection coil; and
a second detection terminal that is electrically connected to the first detection terminal via the detection coil,
wherein the drive coil and the fixed terminal are not electrically connected to the detection coil in a section from the first detection terminal to the second detection terminal via the detection coil.

18. A detection system comprising:
the electromagnetic relay according to claim 2; and
a controller that is electrically connected to the detection coil of the electromagnetic relay,
wherein the controller determines welding between the fixed terminal and the movable contactor based on a conductance or an inductance of the detection coil.

19. The detection system according to claim 18, wherein
power supply to the detection coil is performed before power supply to the drive coil is started, and
the power supply to the drive coil is performed after the power supply to the detection coil is stopped.

20. The detection system according to claim 18, wherein power supply to the detection coil is performed after power supply to the drive coil is stopped.
